(19) United States
(12) Patent Application Publication
(10) Pub. No.: US 2013/0007763 A1
(43) Pub. Date: Jan. 3, 2013

(54) GENERATING METHOD, SCHEDULING METHOD, COMPUTER PRODUCT, GENERATING APPARATUS, AND INFORMATION PROCESSING APPARATUS

(75) Inventors: Koichiro Yamashita, Hachioji (JP); Hiromasa Yamauchi, Kawasaki (JP); Kiyoshi Miyazaki, Machida (JP)

(73) Assignee: FUJITSU LIMITED, Kawasaki-shi (JP)

(21) Appl. No.: 13/613,972

(22) Filed: Sep. 13, 2012

Related U.S. Application Data
(63) Continuation of application No. PCT/JP2010/054609, filed on Mar. 17, 2010.

(51) Int. Cl. G06F 9/46; G06F 9/44

(52) U.S. Cl. 718/104; 703/21

(57) ABSTRACT

A generating method is executed by a processor. The method includes executing simulation using a simulation model expressing a processor model, a memory model to which the processor model is accessible, and a load source that accesses the memory model according to an access contention rate, to obtain an index value for performance of the processor model, for each access contention rate; and saving to a memory area and as contention characteristics information, the index value for each access contention rate.

### CROSS REFERENCE TO RELATED APPLICATIONS

This application is a continuation application of International Application PCT/JP2010/054609, filed on Mar. 17, 2010 and designating the U.S., the entire contents of which are incorporated herein by reference.

### FIELD

The embodiments discussed herein are related to a generating method, a scheduling method, a generation program, a scheduling program, a generating apparatus, and an information processing apparatus that generate information and carry out scheduling using the generated information.

### BACKGROUND

Scheduling techniques include static scheduling and dynamic scheduling.

Static scheduling is a scheduling method of embedding in an execution object as a stationary code at the stage of compiling, code for which the executed state is predicted. For example, static scheduling is carried out by causing an executing central processing unit (CPU) for typical coding optimization and load sharing to constantly have given code.

According to static scheduling, a branch ratio is determined in advance in executing a conditional branch process, thereby allowing code generation to executed be in such a way that code with a higher branch probability is put on a cache line. In static scheduling, unnecessary code is never embedded, so that a computing process needed for scheduling is not included in a judgment-required stage. As a result, scheduling overhead hardly arises.

Dynamic scheduling is a scheduling method carried out in such a way that when an uncertain element not clearly known exists at the time of compiling, state information (load of each processor, etc.) is collected when a scheduling event occurs so that an optimum state for each event is computed each time an event occurs. Such a an uncertain element not clearly known at the time of compiling is, for example, a case where the computing volume becomes clear after computation has been executed or a state when different software are executed simultaneously and the load condition is not known until software is actually executed.

Calculations for scheduling are considered to be hard non-deterministic polynomial (NP) problems. In calculations for scheduling, therefore, finding an optimal solution in real time frame is difficult in essence and consequently, usually an approximate solution to the optimal solution is obtained (an approximate solution is regarded as the optimal solution in this specification). Various algorithms have been proposed to obtain such an optimal solution.

For examples related to scheduling, see Japanese Laid-Open Patent Publication Nos. 2007-328416, 2007-18268, and 2000-215186.

Static scheduling as described above, however, poses a problem in that a branch prediction may fail and a further problem in that when an unexpected state arises, the balance of the entire system is lost, whereby system performance drops to an extremely low level.

Dynamically predicting software-related overhead caused by a scheduler, etc., is not efficient. Since values to be processed are predetermined, static analysis is preferable. Furthermore, a scheduling result may be affected by hardware-related overhead, such as access contention that arises when shared memory is accessed in a multi-core environment.

In such a case, an attempt to predict a pattern at the next event will be met by a changed pattern at the next event. Hence, dynamic prediction becomes meaningless. Therefore, if scheduling events occur frequently in dynamic scheduling, scheduling overhead for determining an optimal solution causes system performance to deteriorate, which is a problem.

### SUMMARY

According to an aspect of an embodiment, a generating method is executed by a processor. The method includes executing simulation using a simulation model expressing a processor model, a memory model to which the processor model is accessible, and a load source that accesses the memory model according to an access contention rate, to obtain an index value for performance of the processor model, for each access contention rate; and saving to a memory area and as contention characteristics information, the index value for each access contention rate.

According to another aspect of an embodiment, a scheduling method is executed by an information processing apparatus including a multi-core processor and a table referenced when each program is called and storing a scheduling method for each program when the program is simultaneously executed with a different program. The scheduling method includes specifying a subject program; detecting a program under execution by a processor in the multi-core processor; identifying a scheduling method for the subject program when the subject program is executed simultaneously with the detected program, by referring to the table; determining from among processors of the multi-core processor, a processor that is to execute the subject program according to the identified scheduling method; and assigning the subject program to the determined processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a generating apparatus according to an embodiment;

FIG. 2 is an explanatory diagram of one example of a profile tag table T;

FIG. 3 is an explanatory diagram of an example of code for a load source L;

FIG. 4 is a block diagram of one example of an information processing apparatus according to the embodiment;

FIG. 5 is an explanatory diagram of a first ESL simulation in the embodiment;

FIG. 6 is a graph of contention characteristics information 120;

FIG. 7 is an explanatory diagram of a second ESL simulation according to the embodiment;

FIG. 8 is an explanatory diagram of one example of the profile tag table T after entry;

FIG. 9 is a block diagram of a hardware configuration of a generating apparatus 100 according to the embodiment;

FIG. 10 is a block diagram of a functional configuration of the generating apparatus 100 according to the embodiment;

FIG. 11 is a block diagram of a functional configuration of an information processing apparatus 400;

FIG. 12 is a flowchart of a procedure of the first ESL simulation by the generating apparatus 100 according to the embodiment;

FIG. 13 is a flowchart of a procedure of the second ESL simulation;

FIG. 14 is a flowchart of an entry procedure of making entries to the profile tag table T;

FIG. 15 is a flowchart of a procedure of a scheduling process by the information processing apparatus 400;

FIG. 16 is a diagram of an example of scheduling failure when the embodiment is not applied;

FIG. 17 is an explanatory diagram of scheduling in a case where the embodiment is applied; and

FIG. 18 is an explanatory diagram of scheduling in another case where the embodiment is applied.

### DESCRIPTION OF EMBODIMENTS

A preferred embodiment of the present invention will be explained with reference to the accompanying drawings.

According to the embodiment, when a program (a process or thread in given application software, i.e., “a given function”) is being executed in a given processor in a multi-core processor system, a scheduling method is determined in advance at the design stage. The scheduling method dictates how a program (a process or thread in different application software, i.e., “a differing function”) that is to be called should be scheduled. Once a product is made, application software is executed by carrying out scheduling according to the scheduling method determined at the design stage.

In the case of static scheduling, for example, the differing function is assigned to the given processor executing the given function so that both the given and differing functions are executed by time-slicing processing. Because of the time-slicing processing, no contention arises between the given function and the differing function.

In the case of dynamic scheduling, however, the differing function is assigned to another processor (e.g., an idle processor) different from the given processor executing the given function.

In this manner, system performance is improved by carrying out static scheduling as much as possible even in a case where dynamic scheduling is inevitable, in order to reduce scheduling overhead that deteriorates system performance. The embodiment will be described in detail with reference to the accompanying drawings.

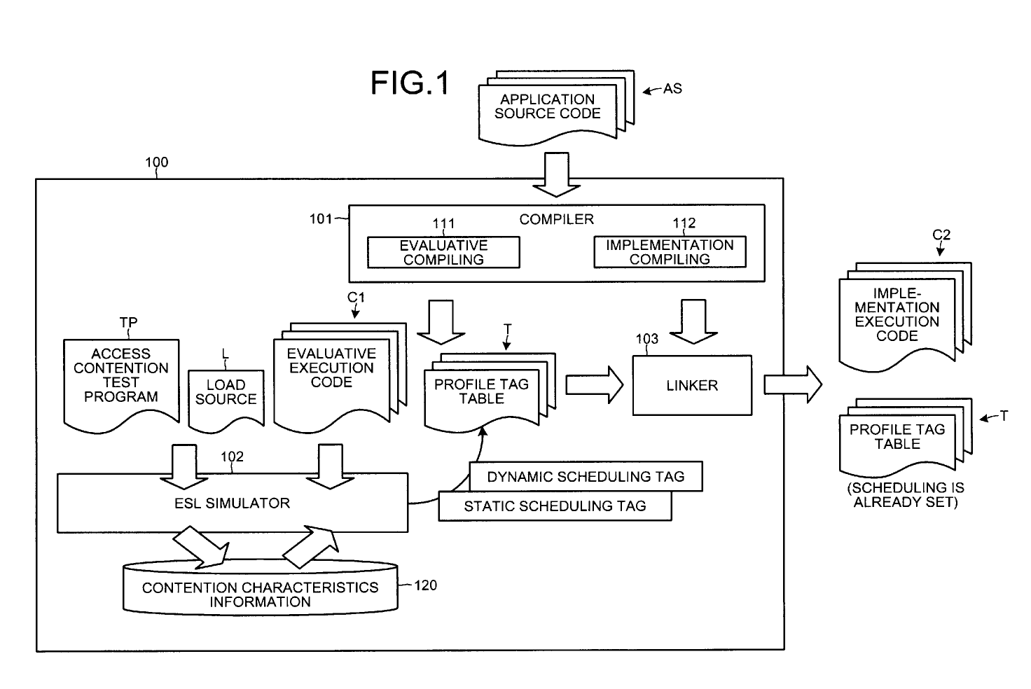

FIG. 1 is an explanatory diagram of an example of a generating apparatus according to the embodiment. A generating apparatus 100 receives input of application source code AS and outputs implementation execution code C2 and profile tag tables T.

The generating apparatus 100 includes a complier 101, an electronic system level (ESL) simulator 102, and a linker 103. The complier 101 executes evaluation compiling 111 and implementation compiling 112 for each application source code AS. The evaluation compiling 111 is a process of generating evaluative execution code C1 for the application source code AS.

The evaluative execution code C1 is execution code made by embedding debug information in ordinary execution code (implementation execution code C2 in FIG. 1). The evaluative execution code C1 may also be referred to as evaluation object. Because of this embedded debug information, the evaluative execution code C1 carries out extra operations in addition to the operation carried out by the implementation execution code C2. The evaluation compiling 111 is executed to generate profile tag tables T.

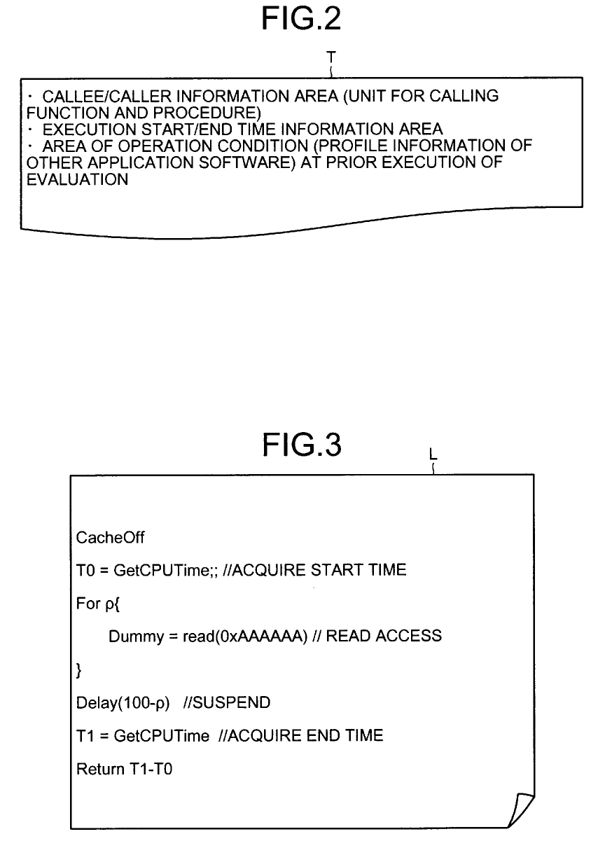

FIG. 2 is an explanatory diagram of one example of the profile tag table T. The profile tag table T is a table having a callee/caller information area and an execution start/end time information area. The callee/caller information area is an area having records of callee information and caller information that is a unit for calling a function and a procedure. The execution start/end time information area is an area for recording a start time and an end time of execution of a function in the evaluative execution code C1.

According to the embodiment, the profile tag table T also has an operation condition area, which is an area for recording the operation condition for the prior execution of evaluation. Briefly, a scheduling method for a given function is recorded in the operation condition area, the details of which, however, will be described later. Each area is empty when the profile tag table T is generated, and is filled as a result of execution of the evaluative execution code C1.

In FIG. 1, the ESL simulator 102 executes ESL simulation. ESL modeling refers to a technique of simulating a hardware environment by describing a model based on behavior of a hardware device. For example, ESL modeling of a processor does not directly simulate a mechanism similar to an electric circuit for command issuing but expresses the mechanism with issued commands and times required therefor.

Likewise, ESL modeling of a bus does not strictly calculate delays in data propagation caused by a circuit mechanism but simulates operation and time concepts as behavior by combining access requests with design-based latency patterns.

Conventionally, simulation has been used for a verification process in which simulation is carried out without actual packaging of a semi-conductor device, based on circuit design information, such as Register Transfer Level (RTL), to realize an operation equivalent to an operation by an actual semi-conductor device.

However, carrying out detailed simulation at a circuit level takes an extremely long time (normally, it takes a process time of 1/several tens-of-millions to hundreds-of-millions of the speed of an actual device), which in practice makes it difficult in that the behavior of the entire system is analyzed while application software continues to run. In contrast, ESL modeling analyzes process and time concepts as behavior, thereby creating an environment in which an approximate process time can be evaluated without carrying out circuit simulation.

In the embodiment, two types of ESL simulation are executed. One is ESL simulation for generating contention characteristics information 120 (hereinafter “first ESL simulation”). The other is ESL simulation of executing the evaluative execution code C1 using the contention characteristics information 120 (hereinafter “second ESL simulation”).

The first ESL simulation generates the contention characteristics information 120 for an information processing apparatus equipped with a multi-core processor system. An ESL system model used when the contention characteristics information 120 is generated is not a system model of the same configuration as that of the multi-core processor system. Multiple CPU models are prepared as a system model of the multi-core processor system. In this case, one CPU model is prepared while the remaining CPU models are grouped and modeled by a single load source L.

In other words, how the remaining CPU models each behaves in response to application software is irrelevant. What is required is to observe how much transaction load the group of the CPU models apply to shared memory. Grouping the rest of CPU models into the load source L, therefore, poses no problem but rather achieves higher simulation speed.

In the first ESL simulation, when the contention characteristics information 120 is generated, an access contention test program TP is executed on the ESL system model. The access contention test program TP is an I/O-based benchmark program, reading and writing data on a shared resource (e.g., shared memory).

The load source L is a model falsely representing a group of CPU models that execute programs other than the access contention test program TP. How each of the CPU models actually behaves in response to application software is irrelevant, and observing how much transaction load the group of CPU models apply to the shared memory is required. Grouping the CPU models into the load source L, therefore, poses no problem but rather achieves higher simulation speed.

FIG. 3 is an explanatory diagram of an example of code for the load source L. The load source L is a program that intentionally causes contention. The intensity of the access contention state (access contention rate ρ) serves as a parameter.

In the second ESL simulation of FIG. 1, aside from the ESL system model having the load source L, each evaluative execution code C1 is executed on a system model created by ESL modeling of the multi-core processor system to be implemented. As a result, a scheduling method is determined for each function in the evaluative execution code C1 and is entered in the profile tag table T.

In this manner, a scheduling method for a differing function is determined depending on a combination of the differing function and a given function that is under execution. Subsequently, the compiler 101 carries out the implementation compiling 112 for each application source code AS to acquire a group of the implementation execution codes C2. When the implementation execution code C2 is executed, profile tag table T to which the implementation execution code C2 is linked by the linker 103 becomes clear. As a result, for each implementation execution code C2, a combination of the implementation execution code C2 and the profile tag table T corresponding thereto is output.

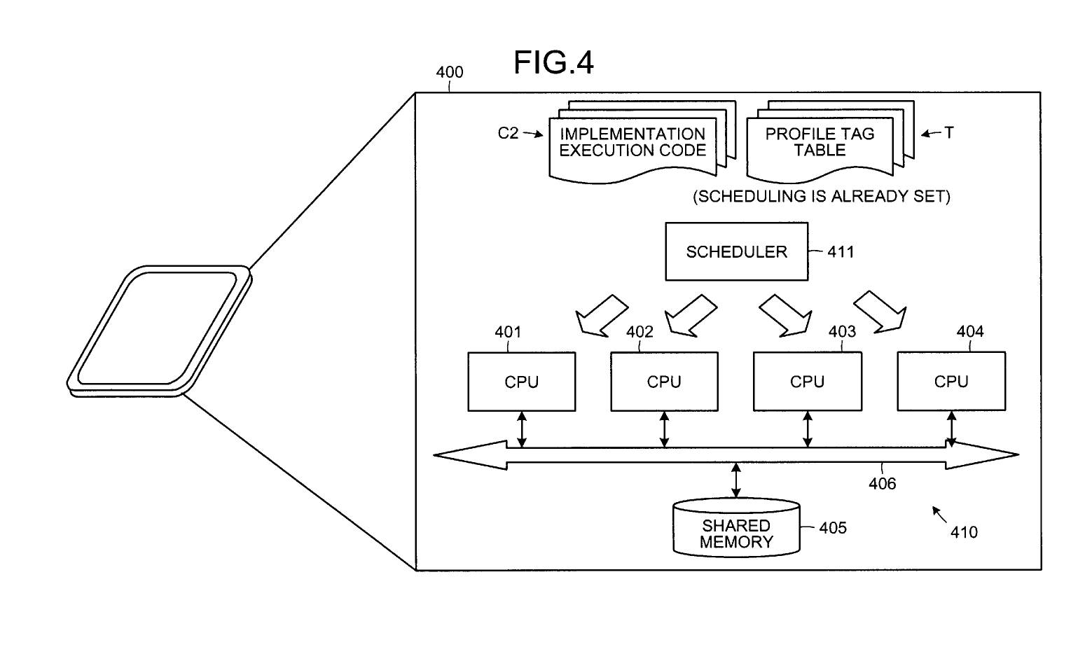

FIG. 4 is a block diagram of one example of an information processing apparatus according to the embodiment. An information processing apparatus 400 is a computer equipped with a multi-core processor system 410 in which a multi-core processor (in FIG. 4, for example, having four CPUs 401 to 404) and shared memory 405 are interconnected via a bus 406. The information processing apparatus 400 is, for example, a portable terminal, such as a cellular phone, a PHS device, a smart phone, a portable game device, electronic dictionary, electronic book terminal, and notebook PC.

A scheduler 411 serving as an operating system (OS) refers to the implementing execution codes C2 and the profile tag tables T and schedules functions in the implementing execution codes C2 that the scheduler 411 intends to start. This enables dynamic or static scheduling. A specific operation of the ESL simulator 102 depicted in FIG. 1 will be described.

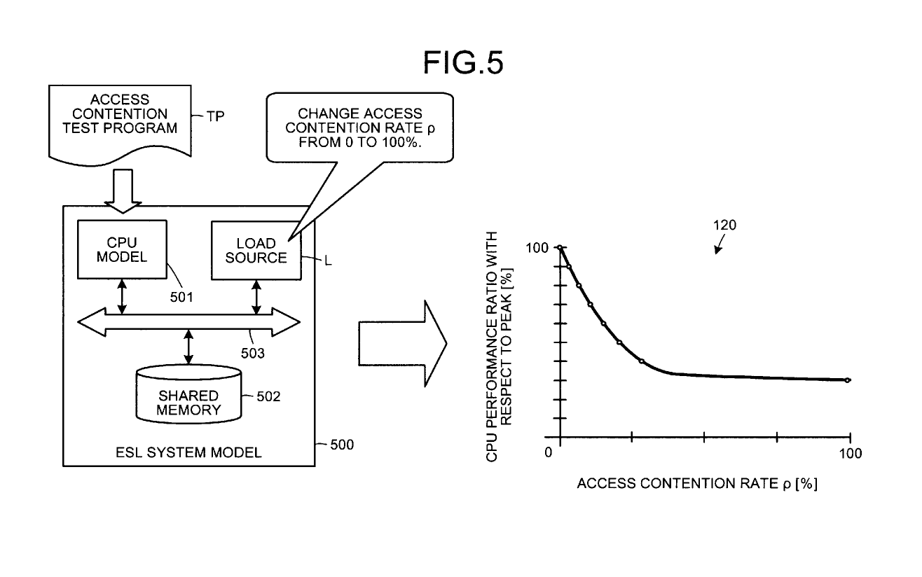

FIG. 5 is an explanatory diagram of the first ESL simulation in the embodiment. The ESL simulator 102 uses a system model 500 in which a CPU model 501, the load source L depicted in FIG. 3, and a shared memory model 502 are interconnected via a bus model 503. The load source L autonomously changes the access contention rate ρ from 0 to 100[%] in units of, for example, Δρ, which may be set arbitrarily to 1[%], etc. The contention characteristics information 120 indicates the performance of the CPU model 501 for the access contention rate.

For example, if a score on the access contention test program TP is 9:1 (9 for the CPU model 501 having executed the access contention test program TP and 1 for the load source L) when the access contention rate ρ is of a given value, the CPU performance ratio at the access contention rate ρ of this value is 90[%]. This means that the CPU performance has deteriorated by 10[%] consequent to the load source L.

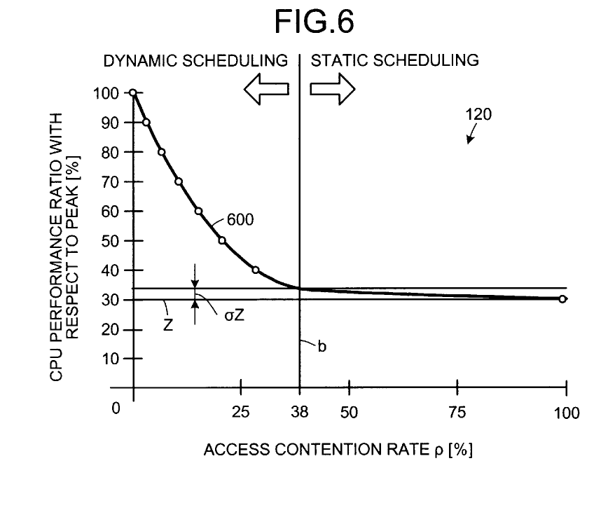

FIG. 6 is a graph of the contention characteristics information 120. In FIG. 6, the horizontal axis represents the access contention rate and the vertical axis represents the CPU performance ratio for the peak. The CPU performance ratio for the peak is the CPU performance ratio defined by determining the CPU performance when a load applied by the load source L is zero (ρ=0) to be 100[%], i.e., the peak.

In ordinary architecture, the contention characteristics information 120 comes to saturate at (asymptotic to) a given value as the access contention rate increases. This is consequent to access certainly becoming possible in a given period as a result of hardware arbitration.

Actually, the CPU performance ratio is plotted in units of Δρ. Using plotted points, an approximation of the contention characteristics information 120 is generated by a known technique, such as the least squares method. This approximation is graphed to create a contention characteristics curve 600. From the approximation (contention characteristics curve 600), a performance asymptotic value Z is derived. The performance asymptotic value Z is derived by determining the CPU performance ratio that results when the value of ρ in the approximation is increased to infinity. In a simpler way, the CPU performance ratio in a case of ρ=100[%] may be determined to be the performance asymptotic value Z.

An allowance value rate σ for the determined performance asymptotic value Z is set. For example, σ=10[%] is set. The access contention rate ρ when the CPU performance ratio given by adding σ[%] of the performance asymptotic value Z to the performance asymptotic value Z crosses the contention characteristics curve 600 is determined to be a boundary value b. When the access contention rate ρ is equal to or higher than the boundary value b, it is judged that static scheduling should be carried out. When the access contention rate ρ is lower than the boundary value b, it is judged that dynamic scheduling should be carried out.

In FIG. 6, when the performance asymptotic value Z is the CPU performance ratio of 30[%] and the allowance value rate σ is 10[%], the access contention rate ρ of 38[%] is determined to be the boundary value b for performance deterioration. This means that the boundary value b serving as the boundary for performance deterioration is set as a performance ratio lower than the peak (100[%]) by 70[%] is equivalent to the performance asymptotic value Z. The allowance value rate σ is set according to the architecture (multi-core processor system).

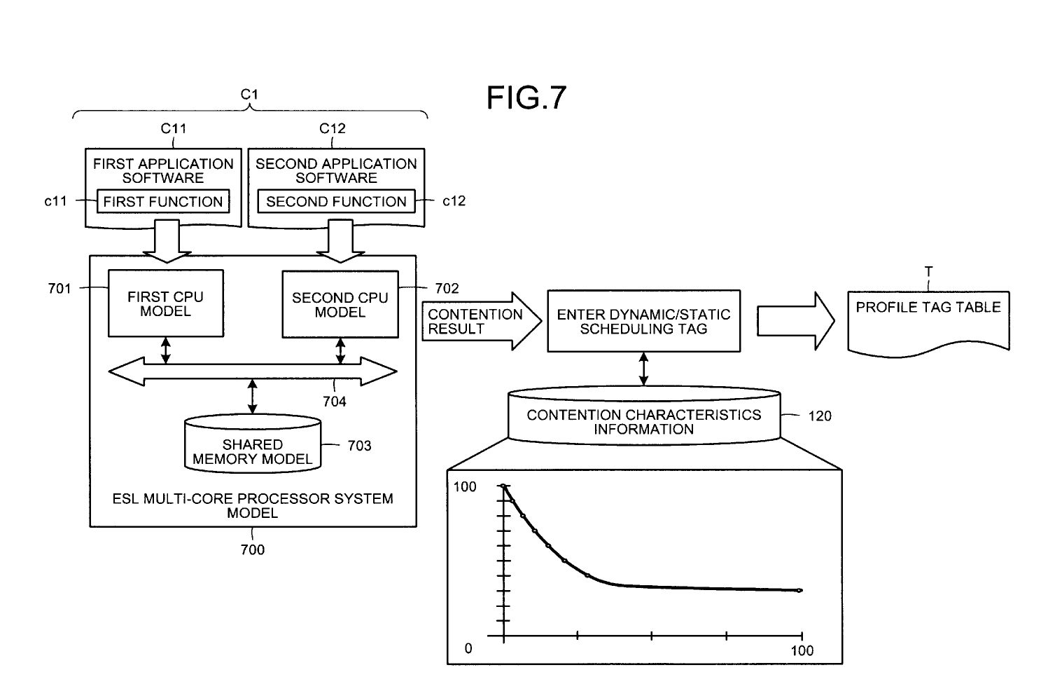

FIG. 7 is an explanatory diagram of the second ESL simulation according to the embodiment. In FIG. 7, a system model 700 of a multi-core processor system is used, in which two CPU models 701 and 702 and a shared memory model 703 are interconnected via a bus model 704. A second function c12, such as a process and a thread in second application software C12, is assigned to the second CPU model 702, which executes the second function c12. A function c11, which is a callee function in first application software C11 that is different from the second application software C12, is assigned to the first CPU model 701.

For example, it is assumed that a function B1 of application software B is executed in the second CPU model 702. In this case, when a function A1 of first application software A is called as a first function and is executed by the first CPU model 701, access contention arises at the shared memory model 703. The CPU performance ratio of the first CPU model 701 is extracted as a contention result by the second ESL simulation. The CPU performance ratio as the contention result is at its peak when the second CPU model 702 is not executing any function, i.e., is in a non-load state.

The contention result is then applied to the approximation (contention characteristics curve 600) of the contention characteristics information 120 to determine an access contention rate ρ of the first CPU model 701 when its CPU performance ratio is the contention result. When this access contention rate ρ is lower than the boundary value b, dynamic scheduling is selected as a scheduling method for the function A1 of the application software A.

When the access contention rate ρ is equal to or higher than the boundary value b, however, static scheduling is selected as a scheduling method for the function A1 of the application software A. The selected scheduling method is entered in the operation condition area in the profile tag table T for the application software A, as the scheduling method for the function A1 in the case of the function B1 being under execution.

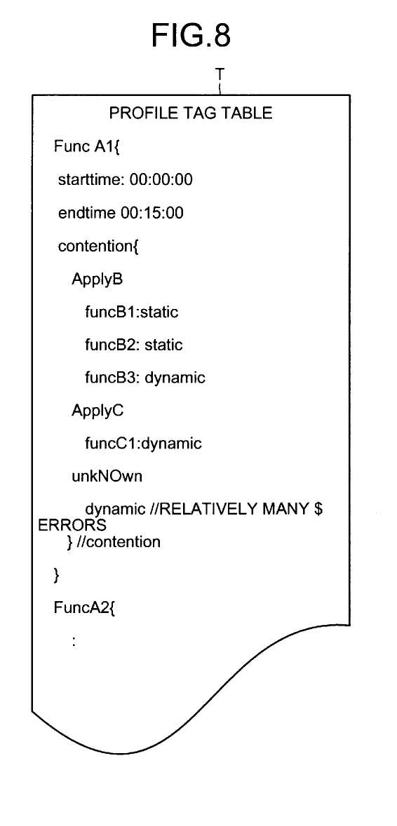

FIG. 8 is an explanatory diagram of one example of the profile tag table T after scheduling method entry. FIG. 8 depicts the entry contents of the application software A in the profile tag table T. The profile tag table T establishes the callee/caller information area, the execution start/end time information area, and the operation condition area for each function. In FIG. 8, however, the callee/caller information area is omitted for simplicity. In the profile tag table T, a description ranging from “contention {“ to ”}//contention” is the operation condition area for a function to be scheduled.

For example, when the function A1 (“funcA1”) is a callee function, if the function under execution is the function B1 (“funcB1”) of each application software B (“ApplyB”), “static” is entered. This indicates that if the function A1 is called during execution of the function B1 of application software B, static scheduling is carried out. In this case where contention keeps arising, contention is cancelled by static scheduling, for example, by assigning the function A1 to the same processor processing the function B1 and carrying out a time slice operation.

If a function under execution is a function B3 (“funcB3”) of each application software B, “dynamic” is entered. This indicates that if the function A1 is called during execution of the function B3 of application software B, dynamic scheduling is carried out. In this case, the effect of application software B is low or the overhead resulting from an operation state changes over a wide range, so that the function A1 is assigned dynamically to a CPU with the lightest load.

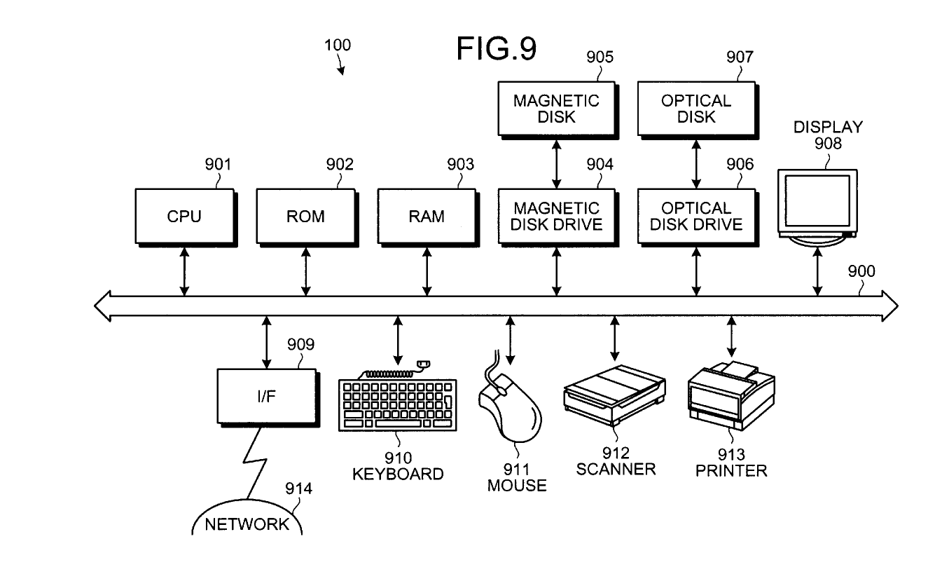

FIG. 9 is a block diagram of a hardware configuration of the generating apparatus according to the embodiment. As depicted in FIG. 9, the generating apparatus includes a central processing unit (CPU) 901, a read-only memory (ROM) 902, a random access memory (RAM) 903, a magnetic disk drive 904, a magnetic disk 905, an optical disk drive 906, an optical disk 907, a display 908, an interface (I/F) 909, a keyboard 910, a mouse 911, a scanner 912, and a printer 913, respectively connected by a bus 900.

The CPU 901 governs overall control of the generating apparatus. The ROM 902 stores therein programs such as a boot program. The RAM 903 is used as a work area of the CPU 901. The magnetic disk drive 904, under the control of the CPU 901, controls the reading and writing of data with respect to the magnetic disk 905. The magnetic disk 905 stores therein data written under control of the magnetic disk drive 904.

The optical disk drive 906, under the control of the CPU 901, controls the reading and writing of data with respect to the optical disk 907. The optical disk 907 stores therein data written under control of the optical disk drive 906, the data being read by a computer.

The display 908 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 908.

The I/F 909 is connected to a network 914 such as a local area network (LAN), a wide area network (WAN), and the Internet through a communication line and is connected to other apparatuses through the network 914. The I/F 909 administers an internal interface with the network 914 and controls the input/output of data from/to external apparatuses. For example, a modem or a LAN adaptor may be employed as the I/F 909.

The keyboard 910 includes, for example, keys for inputting letters, numerals, and various instructions and performs the input of data. Alternatively, a touch-panel-type input pad or numeric keypad, etc. may be adopted. The mouse 911 is used to move the cursor, select a region, or move and change the size of windows. A track ball or a joy stick may be adopted provided each respectively has a function similar to a pointing device.

The scanner 912 optically reads an image and takes in the image data into the generating apparatus. The scanner 912 may have an optical character reader (OCR) function as well. The printer 913 prints image data and text data. The printer 913 may be, for example, a laser printer or an ink jet printer.

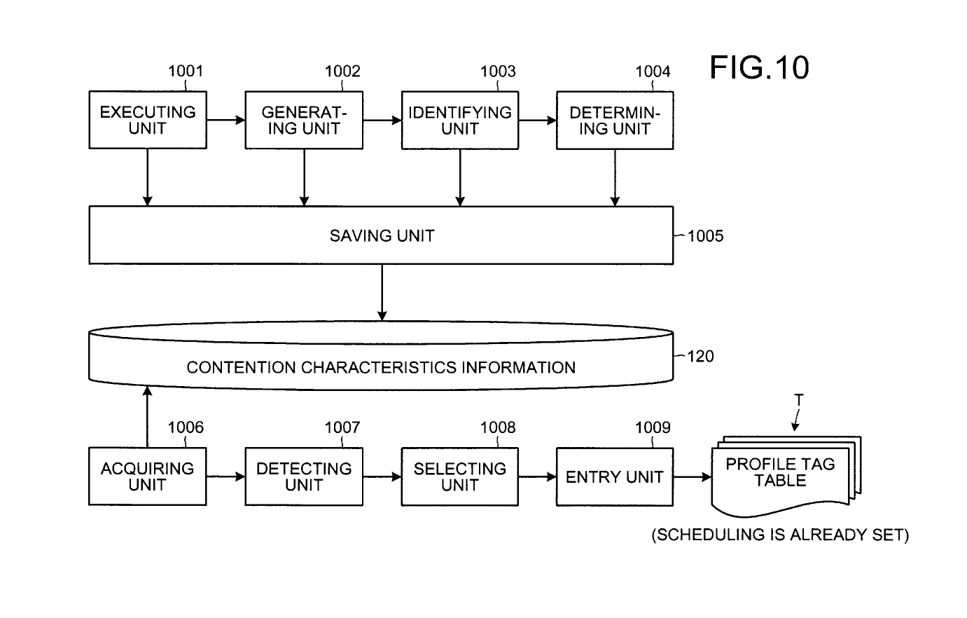

FIG. 10 is a block diagram of a functional configuration of the generating apparatus 100 according to the embodiment. The generating apparatus 100 includes an executing unit 1001, a generating unit 1002, an identifying unit 1003, a determining unit 1004, a saving unit 1005, an acquiring unit 1006, a detecting unit 1007, a selecting unit 1008, and an entry unit 1009. For example, the functions of the executing unit 1001 to the entering unit 1009 are realized by causing the CPU 901 to execute programs stored in memory devices depicted in FIG. 9, such as the ROM 902, RAM 903, and magnetic disk 905.

The executing unit 1001 has a function of executing the first ESL simulation. For example, for example, the executing unit 1001 executes the first ESL simulation using the system model in FIG. 5. The executing unit 1001 then acquires, for example, the CPU performance ratio to the peak, as an index value for the performance of a CPU model, which is an execution result. Because the access contention rate ρ changes from 0 to 100[%] in units of Δρ in the first ESL simulation, the CPU performance ratio to the peak is acquired for each access contention rate ρ.

The generating unit 1002 has a function of generating an approximation of the contention characteristics of a processor based on an index value for the performance of a processor model determined for each access contention rate. For example, since the executing unit 1001 acquires the CPU performance ratio to the peak for each access contention rate ρ, the generating unit 1002 generates an approximation of the contention characteristics information 120 by applying a known technique, such as the least squares method, to each CPU performance ratio. When access contention arises, the contention characteristics attenuate in the form of an exponential function or logarithmic function. For this reason, it is preferable to express the model curve 600 as an exponential function curve or logarithmic function curve.

The identifying unit 1003 has a function of identifying the performance asymptotic value Z to which the performance of the processor model is asymptotic, from among index values for the performance of the processor model and based on an approximation of the contention characteristics generated by the generating unit 1002. For example, for example, the identifying unit 1003 determines the performance asymptotic value Z from the contention characteristics curve 600.

The determining unit 1004 has a function of determining from among access contention rates and based on the approximation and an allowable error value for the performance asymptotic value Z identified by the identifying unit 1003, an access contention rate to be the boundary value b for the performance deterioration of the processor model. For example, the determining unit 1004 determines an access contention rate ρ corresponding to an intersection between the allowable error value for the performance asymptotic value Z acquired from the allowable value rate σ and the contention characteristics curve 600, to be the boundary value b.

The saving unit 1005 has a function of saving the contention characteristics information 120 acquired from the executing unit 1001, the generating unit 1002, the identifying unit 1003, and the determining unit 1004 to a memory area. The saved characteristics information 120 is used for the second ESL simulation.

The acquiring unit 1006 has a function of executing the second ESL simulation and acquiring a performance index value as an execution result. For example, the acquiring unit 1006 executes the second ESL simulation using the multi-core processor system model of FIG. 7, and acquires, for example, the CPU performance ratio to the peak of the first CPU model 701, as an index value for the performance of the first CPU model 701, the index value being an execution result.

The detecting unit 1007 has a function of referring to the approximation and detecting an access contention rate at the index value acquired by the acquiring unit 1006. For example, the detecting unit 1007 detects the access contention rate ρ corresponding to the acquired CPU performance ratio from the contention characteristics curve 600.

The selecting unit 1008 has a function of comparing the detected access contention rate ρ and the boundary value b to select from among dynamic scheduling and static scheduling, a scheduling method for a case of executing a first program during execution of a second program. For example, in the second ESL simulation in FIG. 7, the selecting unit 1008 selects a scheduling method for a case of executing a first function during execution of a second function. For example, when the detected access contention rate ρ is equal to or higher than the boundary value b, static scheduling is selected. When the access contention rate ρ is lower than the boundary value b, dynamic scheduling is selected.

The entry unit 1009 has a function of entering the scheduling method selected by the selecting unit 1008 into the profile tag table T. For example, as depicted in FIG. 8, the entry unit 1009 enters a tag “static” for the scheduling method (e.g., static scheduling) selected for the first function A1 (first function), as a tag correlated with the function B1.

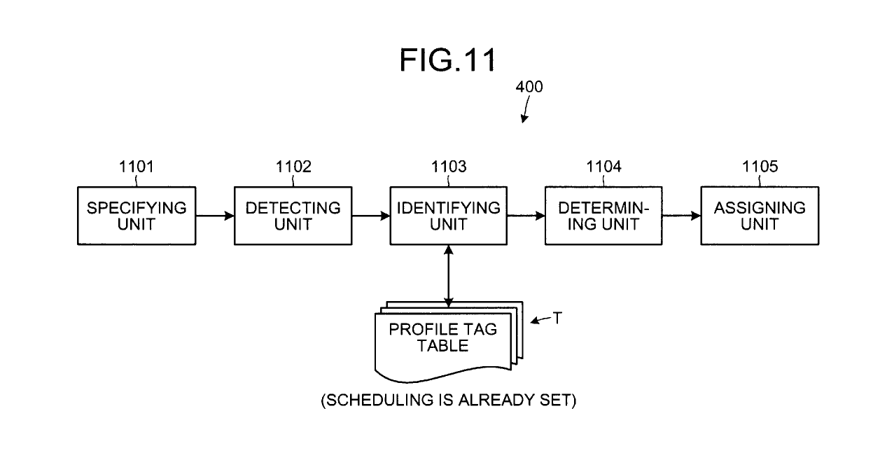

FIG. 11 is a block diagram of a functional configuration of the information processing apparatus 400. The information processing apparatus 400 includes a specifying unit 1101, a detecting unit 1102, an identifying unit 1103, a determining unit 1104, and an assigning unit 1105. For example, the functions of the specifying unit 1101 to the assigning unit 1105 are realized by causing the CPUs 401 to 404 to execute programs stored in a memory device, such as the shared memory 405.

The specifying unit 1101 has a function of specifying a subject program. For example, for example, the specifying unit 1101 specifies a callee function in called application software.

The detecting unit 1102 has a function of detecting a program being executed by a processor in the multi-core processor when a subject program is specified by the specifying unit 1101. For example, when the specifying unit 1101 specifies the function A1 as a callee function, the detecting unit 1102 detects a CPU executing the function B1, which is different from the function A1, in the multi-core processor and retains the CPU number of the CPU.

The identifying unit 1103 has a function of referring to the table and specifying a scheduling method for scheduling a subject program, for a case where the subject program is executed simultaneously with a program under execution that is detected by the detecting unit 1102. For example, the identifying unit 1103 refers to the profile tag table T of application software including a callee function; reads from the table T, the scheduling method for the function A1 in a case of the function B1 being under execution; and identifies the read scheduling method as static scheduling or dynamic scheduling. Reading “static” means static scheduling while reading “dynamic” means dynamic scheduling.

The determining unit 1104 has a function of determining a processor to execute a subject program according to the scheduling method identified by the identifying unit 1103, from among processors of the multi-core processor. For example, when the scheduling method identified by the identifying unit 1103 is static scheduling, the determining unit 1104 determines the processor to execute the subject program to be the processor to which the program under execution is assigned. For example, a scheduling method for the function A1 during execution of the function B1 is static scheduling, in which case the CPU number of the CPU that executes the function B1 is read out.

When the scheduling method identified by the identifying unit 1103 is dynamic scheduling, the determining unit 1104 determines the processor to execute the subject program to be the processor having the smallest load among processors other than the processor to which the program under execution is assigned.

For example, as indicated in FIG. 8, a scheduling method for the function A1 during execution of the function B3 is dynamic scheduling. Hence, the determining unit 1104 determines a CPU among a group of CPUs other than the CPU executing the function B1, to be assigned the function A1. For example, the determining unit 1104 determines a CPU in an idle state among the group of CPUs to be assigned the function A1. If a CPU in an idle state is not present, the determining unit 1104 determines the CPU having the smallest load among the group of CPUs to be assigned the function A1. The OS possesses information concerning CPU loads by an existing technique.

The assigning unit 1105 has a function of assigning a subject program to the processor determined by the determining unit 1104. For example, the assigning unit 1105 informs the CPU determined by the determining unit 1104 of a callee function, i.e., the subject program. For example, by being informed of the address in a shared memory in which the callee function is saved, the determined CPU identifies the address and reads the callee function into a cache memory therein to execute the function.

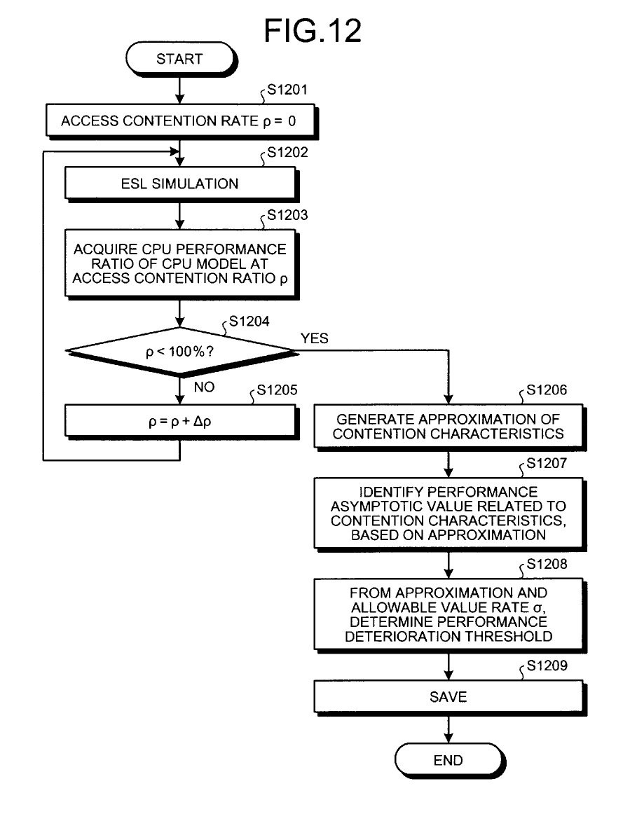

FIG. 12 is a flowchart of a procedure of the first ESL simulation by the generating apparatus 100 according to the embodiment. The generating apparatus 100 first causes the executing unit 1001 to set the access contention rate ρ of the load source L in the system model 500 to 0 (step S1201). The generating apparatus 100 then executes ESL simulation using the system model 500 (step S1202).

Through this ESL simulation, the generating apparatus 100 acquires a CPU performance ratio of the CPU model 501 at the access contention ratio ρ (step S1203). The generating apparatus 100 then causes the executing unit 1001 to determine whether ρ<100[%] is satisfied (step S1204).

If ρ<100[%] is not satisfied (step S1204: NO), the generating apparatus 100 adds Δρ to the current ρ (step S1205) and returns to step S1202. If ρ<100[%] is satisfied (step S1204: YES), the generating apparatus 100 generates an approximation of contention characteristics from the acquired CPU performance ratio (step S1206).

Subsequently, the generating apparatus 100 identifies a performance asymptotic value Z related to contention characteristics, based on the generated approximation (step S1207). From the approximation and an allowable value rate σ, the generating apparatus 100 then determines a boundary value b serving as a performance deterioration threshold (step S1208). Subsequently, the generating apparatus 100 saves the boundary value b as contention characteristics information 120 to a memory device (step S1209), and ends the first ESL simulation.

In this manner, the statistical performance deterioration of the CPU that may happen due to contention in a given architecture can be grasped by carrying out the first ESL simulation. A procedure of the second ESL simulation using the contention characteristics information 120 acquired through the first ESL simulation of FIG. 12 will be described.

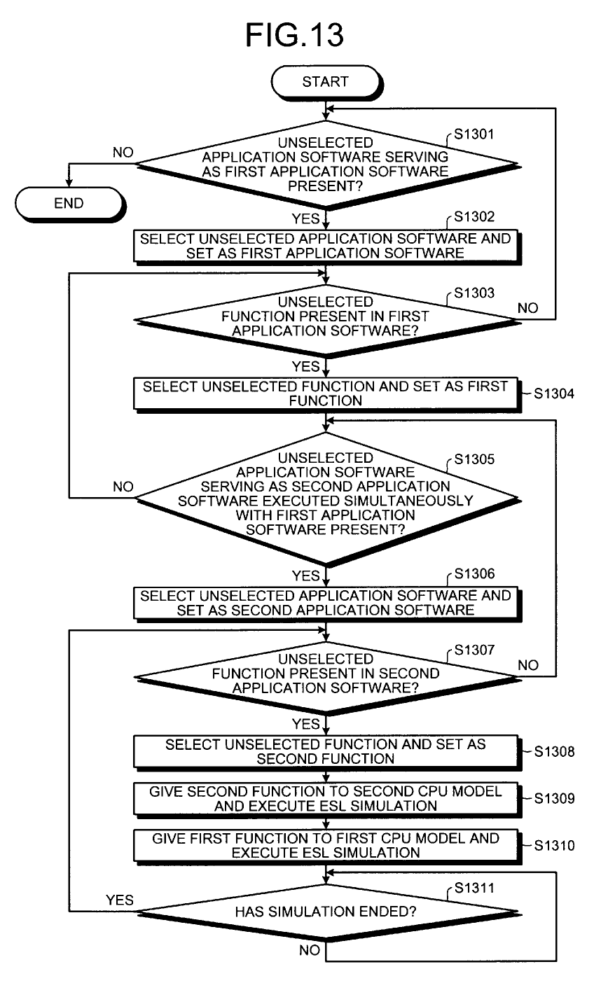

FIG. 13 is a flowchart of a procedure of the second ESL simulation. The generating apparatus 100 causes the acquiring unit 1006 to read in advance a combination of application software to be executed simultaneously. The generating apparatus 100 then determines whether unselected application software (evaluative execution code C1) serving as first application software is present (step S1301). If unselected application software is present (step S1301: YES), the generating apparatus 100 selects the unselected application software and sets the application software as first application software (step S1302).

The generating apparatus 100 then determines whether an unselected function is present in the first application software (step S1303). If an unselected function is present (step S1303: YES), the generating apparatus 100 selects the unselected function and sets the function as a first function (step S1304). The generating apparatus 100 also determines whether unselected application software serving as second application software executed simultaneously with the first application software is present (step S1305).

If unselected application software is present (step S1305: YES), the generating apparatus 100 selects the unselected application software and sets the application software as second application software (step S1306). The generating apparatus 100 then determines whether an unselected function is present in the second application software (step S1307). If an unselected function is present (step S1307: YES), the generating apparatus 100 selects the unselected function and sets the function as a second function (step S1308).

Subsequently, the generating apparatus 100 gives the second function to the second CPU model 702 and executes ESL simulation (step S1309). During execution of the second function, the generating apparatus 100 gives the first function to the first CPU model 701 to which no function is assigned and executes ESL simulation (step S1310). Hence, a CPU performance ratio for the first CPU model 701 that executes the first function is acquired.

For example, when the first CPU model 701 and the second CPU model 702 access the shared memory at their access frequency ratio of 7:3, the CPU performance ratio of the first CPU model 701 to the peak (100[%]) is 70[%]. This means that the performance of the first CPU model 701 deteriorates by 30[%] because the second CPU model 702 is executing the second function. The generating apparatus 100 stands by until the ESL simulation ends (step S1311: NO), and returns to step S1307 when the simulation ends (step S1311: YES).

If an unselected function is not present at step S1307 (step S1307: NO), the generating apparatus 100 returns to step S1305. If unselected application software is not present at step S1305 (step S1305: NO), the generating apparatus 100 returns to step S1303. If an unselected function is not present in the first application software at step S1303 (step S1303: NO), the generating apparatus 100 returns to step S1301.

If unselected application software serving as the first application software is not present at step S1301 (step S1301: NO), the second ESL simulation is ended. In this manner, the second ESL simulation is carried out comprehensively on all combinations of functions.

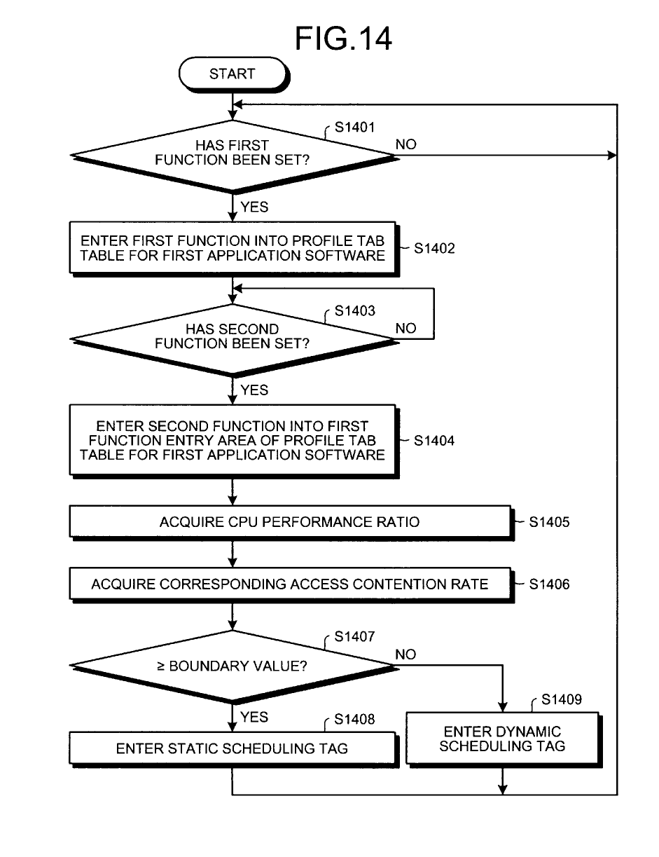

FIG. 14 is a flowchart of an entry procedure of making entries to the profile tag table T. The entry procedure depicted in the flowchart of FIG. 14 is executed in connection with the second simulation of FIG. 13.

The generating apparatus 100 stands by until the first function is set at step S1304 in FIG. 13 (step S1401: NO). When the first function is set (step S1401: YES), the generating apparatus 100 enters the first function into the operation condition area in the profile tab table T for the first application software (step S1402).

The generating apparatus 100 then stands by until the second function is set at step S1308 in FIG. 13 (step S1403: NO). When the second function is set (step S1403: YES), the generating apparatus 100 enters the second function into a first function entry area of the operation condition area in the profile tab table T for the first application software (step S1404).

The generating apparatus 100 then acquires the CPU performance ratio of the first CPU model 701 obtained through the ESL simulation at step S1310 in FIG. 13 (step S1305). When acquiring the CPU performance ratio, the generating apparatus 100 refers to the contention characteristics information 120 and acquires an access contention rate corresponding to the acquired CPU performance ratio (step S1406). The generating apparatus 100 then determines whether the acquired access contention rate is at least the boundary value b (step S1407).

If the acquired access contention rate is equal to or higher than the boundary value b (step S1407: YES), e.g., is in the area on the right of the boundary value b in FIG. 6, the generating apparatus 100 determines that static scheduling should be carried out because of the low CPU performance ratio of the first CPU model 701 and thus, enters a static scheduling tag for the second function (step S1408). In other words, the generating apparatus 100 makes an entry indicating that static scheduling should be carried out when the first function is called during execution of the second function.

In contrast, if the acquired access contention rate is lower than the boundary value b (step S1407: NO), e.g., is in the area on the left of the boundary value b of FIG. 6, the generating apparatus 100 determines that dynamic scheduling should be carried out because of the high CPU performance ratio of the first CPU model 701 and thus, enters a dynamic scheduling tag for the second function (step S1409). In other words, the generating apparatus 100 makes an entry indicating that dynamic scheduling should be carried out when the first function is called during execution of the second function. Following step S1408 or S1409, the generating apparatus 100 returns to step S1401.

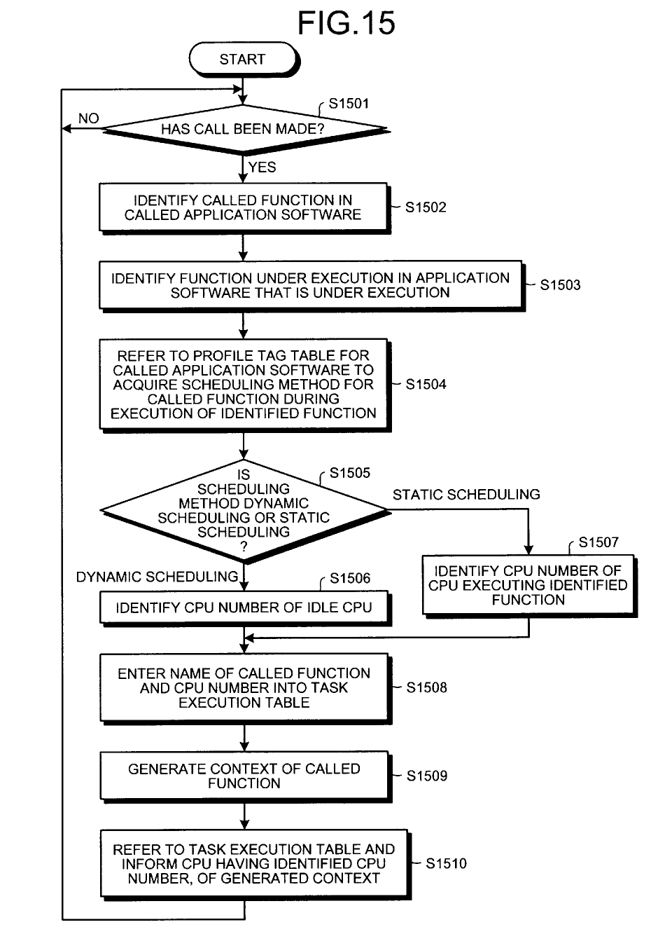

FIG. 15 is a flowchart of a procedure of a scheduling process by the information processing apparatus 400. The scheduler 411 serving as the OS in the information processing apparatus 400 refers to the profile tag table T to carry out the scheduling process.

The information processing apparatus 400 stands by until a call is made (step S1501: NO). When a call is made (step S1501: YES), the information processing apparatus 400 identifies the called function in called application software (step S1502). At the same time, the information processing apparatus 400 identifies a function under execution in application software that is under execution (step S1503).

The information processing apparatus 400 then refers to the profile tag table T for the called application software to acquire a scheduling method for the called function during execution of the identified function (step 1504). For example, in FIG. 8, if the function B1 is the function under execution and the function A1 is the called function, “static” is read out.

The information processing apparatus 400 then determines whether the acquired scheduling method is dynamic scheduling or static scheduling (step S1505). If the scheduling method is dynamic scheduling (step S1505: dynamic), the information processing apparatus 400 identifies the CPU number of an idle CPU (step S1506) and returns to step S1508. If no idle CPU is found, the information processing apparatus 400 identifies the CPU number of the CPU having the smallest load among CPUs other than the CPU executing the function as the function under execution.

If the scheduling method is static scheduling (step S1505: static), the information processing apparatus 400 identifies the CPU number of the CPU executing the function identified as the function under execution (step S1507), and proceeds to step S1508.

At step S1508, the information processing apparatus 400 enters the name of the called function and the CPU number identified at step S1506 or S1507 into a task execution table (step S1508). The information processing apparatus 400 then generates context of the callee function (step S1509), refers to the task execution table and informs the CPU having the identified CPU number of the generated context (step S1510). As a result, the callee function is executed by the CPU informed of the context.

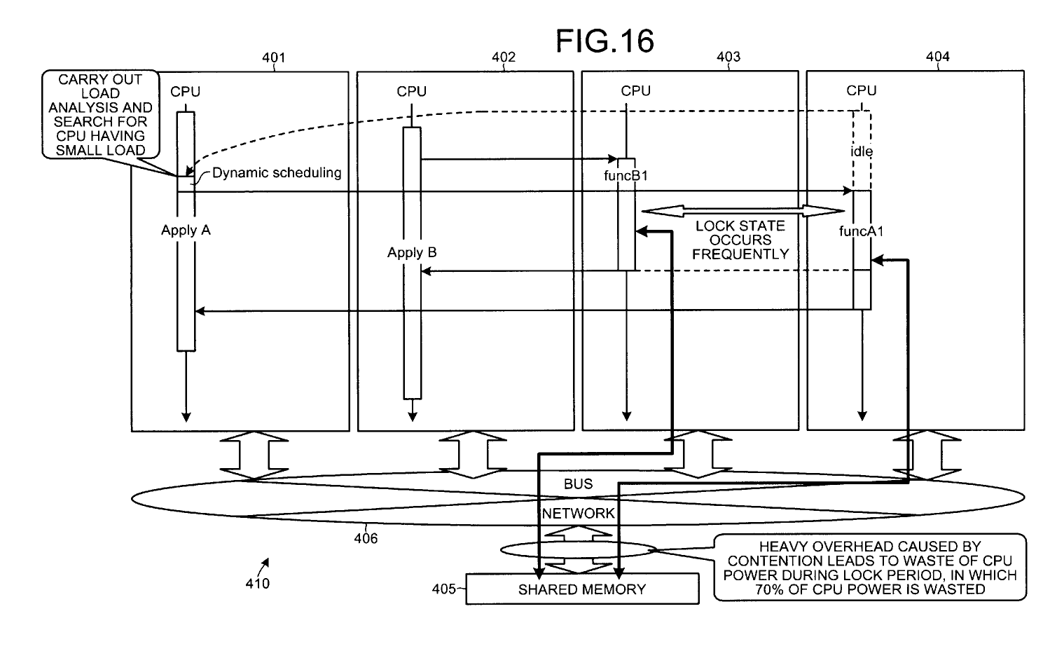

Operation examples will be described referring to FIGS. 16 to 18. In FIGS. 16 to 18, application software A is started at the CPU 401, application software B is started at the CPU 402, the function B1 of the application software B is being executed at the CPU 403, and the CPU 404 is in an idle state. It is assumed that the scheduler 411 is executed at the CPU 401 serving as a master CPU. A case of calling the function A1 of the application software A in this state will be described.

FIG. 16 is a diagram of an example of scheduling failure when the embodiment is not applied. In the case depicted in FIG. 16 where the embodiment is not applied, when the function A1 is called, the scheduler 411 of the CPU 401 identifies the CPU 404, which is in an idle state, and carries out dynamic scheduling. This means that the function A1 as a callee function is assigned to the CPU 404, which is an idle CPU. In this case, a lock state frequently occurs between the function A1 and the function B1. As a result, CPU power is wasted during lock periods.

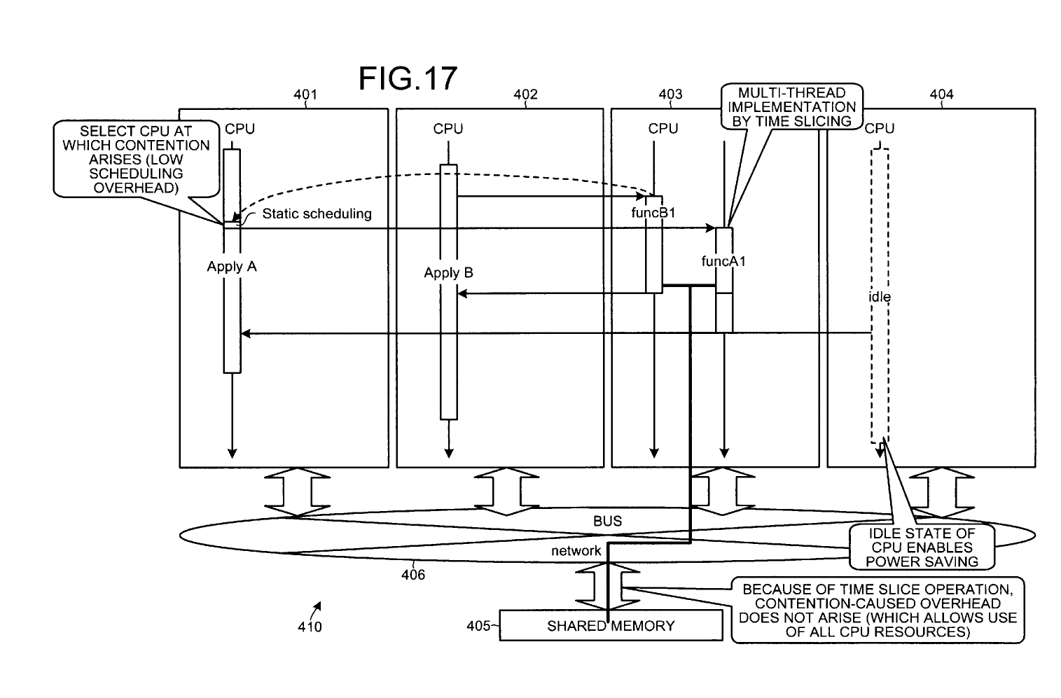

FIG. 17 is an explanatory diagram of scheduling in a case where the embodiment is applied. FIG. 17 depicts a case where static scheduling is carried out. In the case depicted in FIG. 17 where static scheduling of the function A1 is carried out, the function A1 is assigned to the CPU 403 that is executing the function B1. The CPU 403, therefore, processes the function A1 and the function B1 through a time slice operation. As a result, no access contention (overhead) arises at the shared memory.

Hence, performance deterioration due to access contention can be concealed, which allows use of the entire CPU resources. Since the function A1 is not assigned to the CPU 404, the CPU 404 can maintain its idle state and thereby continue to save power. In the case of static scheduling, the scheduler 411 is merely informed of the CPU number of the CPU executing the function B1 and is spared the load of searching for an idle CPU. Hence, scheduling overhead does not arise.

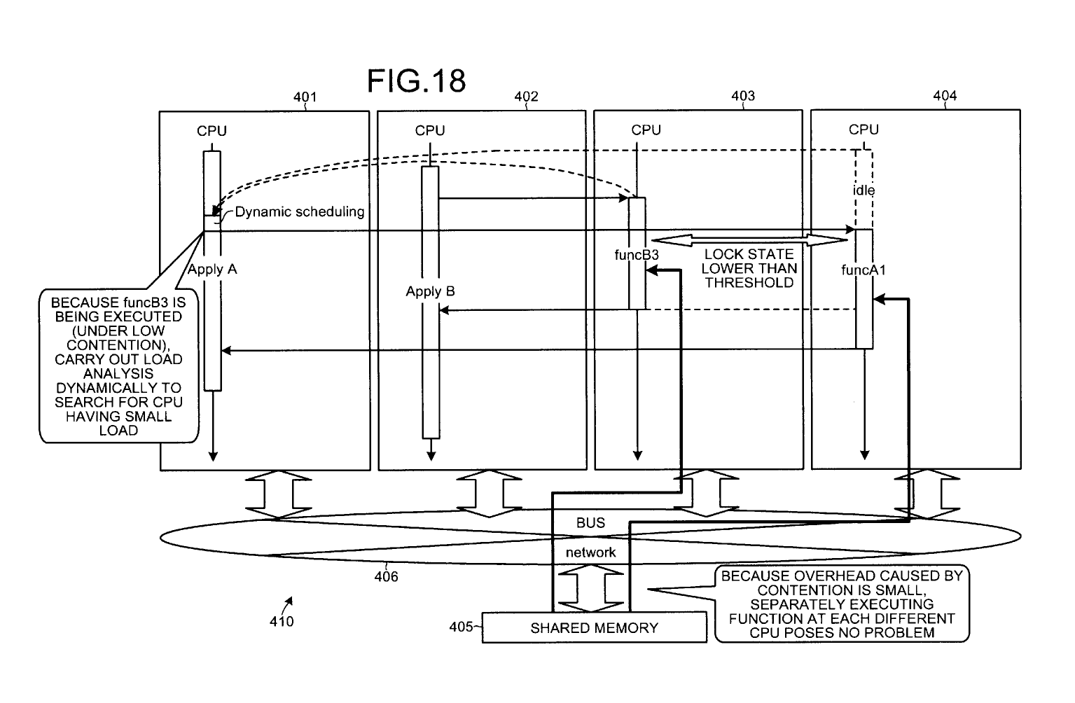

FIG. 18 is an explanatory diagram of scheduling in another case where the embodiment is applied. FIG. 18 depicts a case where dynamic scheduling is carried out. In the case depicted in FIG. 18 where contention related to the function B3 is low, even if the function A1 is assigned to the idle CPU 404 by dynamic scheduling, the CPU 404 operates without a problem despite performance deterioration due to access contention.

In this manner, according to the embodiment, overhead is reduced by implementing static scheduling as much as possible, and dynamic scheduling is implemented only in a situation where an uncertain operation is carried out.

In a case of an embedded system, such as a television system, in which a limited number of operations and application programs are present, static scheduling is relatively effective. However, in a case of a portable terminal etc., which is an embedded system for general-purpose use such that arbitrary application software is operated by arbitrary user operation, inevitably dynamic scheduling cases increase.

By applying the embodiment, static scheduling can be carried out even in a conventional case where dynamic scheduling is inevitable, in order to reduce scheduling overhead that deteriorates system performance. Hence, system performance is improved.

The present invention provides a generating method, a scheduling method, a generation program, a scheduling program, a generating apparatus, and an information processing apparatus that improve system performance by carrying out static scheduling even in a case where dynamic processing is inevitable in order to reduce scheduling overhead that deteriorates system performance.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generating method executed by a processor, the method comprising:
executing simulation using a simulation model expressing a processor model, a memory model to which the processor model is accessible, and a load source that accesses the memory model according to an access contention rate, to obtain an index value for performance of the processor model, for each access contention rate; and
saving to a memory area and as contention characteristics information, the index value for each access contention rate.

2. The generating method according to claim 1, comprising generating an approximation of contention characteristics of the processor model, based on the index value for the performance of the processor model and obtained for each access contention rate, wherein
the saving includes saving the generated approximation to the memory area, as the contention characteristics information.

3. The generating method according to claim 2, comprising identifying a performance asymptotic value to which the performance of the processor model is asymptotic, from among the index values for the performance of the processor model and based on the generated approximation of contention characteristics, wherein
the saving includes saving the identified performance asymptotic value to the memory area, as the contention characteristics information.

4. The generating method according to claim 3, comprising determining from among the access contention rates and based on the approximation and an allowable error value for the performance asymptotic value, an access contention rate to be a boundary value for performance deterioration of the processor model, wherein
the saving includes saving the allowable error value and the determined boundary value to the memory area, as the contention characteristics information.

5. The generating method according to claim 4, comprising:
acquiring an index value for performance of a first processor model when a first program is executed by the first processor model during execution of a second program by a second processor model, the second program being one of the first and second programs in a multi-core processor system model expressing the first processor model, the second processor model, and a shared memory model to which the first and second processor models have access;
detecting the access contention rate for the acquired index value by referring to the approximation;
comparing the detected access contention rate and the boundary value and selecting from among dynamic scheduling and static scheduling, a scheduling method for a case of executing the first program during execution of the second program; and
entering the selected scheduling method into a table referenced when the first program is called.

6. A scheduling method executed by an information processing apparatus including a multi-core processor and a table referenced when each program is called and storing a scheduling method for each program when the program is simultaneously executed with a different program, the scheduling method comprising:
specifying a subject program;
detecting a program under execution by a processor in the multi-core processor;
identifying a scheduling method for the subject program when the subject program is executed simultaneously with the detected program, by referring to the table;
determining from among processors of the multi-core processor, a processor that is to execute the subject program according to the identified scheduling method; and
assigning the subject program to the determined processor.

7. The scheduling method according to claim 6, wherein
the determining includes determining as the processor that is to execute the subject program and when the identified scheduling method is static scheduling, a processor to which the program under execution is assigned.

8. The scheduling method according to claim 6, wherein
the determining includes determining as the processor that is to execute the subject program and when the identified scheduling method is dynamic scheduling, a processor having the smallest load among the processors excluding a processor to which the program under execution is assigned.

9. A computer-readable recording medium storing a program causing a computer to execute a generating process comprising:
executing simulation using a simulation model expressing a processor model, a memory model to which the processor model is accessible, and a load source that accesses the memory model according to an access contention rate, to obtain an index value for performance of the processor model, for each access contention rate; and
saving to a memory area and as contention characteristics information, the index value for each access contention rate.

10. A computer-readable recording medium storing a program causing an information processing apparatus including a multi-core processor and a table that is referenced when each program is called and stores a scheduling method for each program when the program is simultaneously executed with a different program, to execute a scheduling process comprising:
specifying a subject program;
detecting a program under execution by a processor in the multi-core processor;
identifying a scheduling method for the subject program when the subject program is executed simultaneously with the detected program, by referring to the table;
determining from among processors of the multi-core processor, a processor that is to execute the subject program according to the identified scheduling method; and
assigning the subject program to the determined processor.

11. A generating apparatus comprising a processor configured to:
execute simulation using a simulation model expressing a processor model, a memory model to which the processor model is accessible, and a load source that accesses the memory model according to an access contention rate, to obtain an index value for performance of the processor model, for each access contention rate, and save to a memory area and as contention characteristics information, the index value for each access contention rate.

12. An information processing apparatus comprising a multi-core processor and a table referenced when each program is called and storing a scheduling method for each program when the program is simultaneously executed with a different program, wherein
processing units are configured to:
specify a subject program;
detect a program under execution by a processor in the multi-core processor;
identify a scheduling method for the subject program when the subject program is executed simultaneously with the detected program, by referring to the table;
determine from among processors of the multi-core processor, a processor that is to execute the subject program according to the identified scheduling method; and
assign the subject program to the determined processor.
